(19) United States
(12) Patent Application Publication
(10) Pub. No.: US 2021/0080021 A1
(43) Pub. Date: Mar. 18, 2021

(54) VALVE

(71) Applicant: Vitesco Technologies GmbH, Hannover (DE)

(72) Inventor: Rosario BONANNO, Schwalbach a. Ts (DE)

(21) Appl. No.: 16/954,263

(22) PCT Filed: Dec. 17, 2018
(86) PCT No.: PCT/EP2018/085247

§ 371 Date: Jun. 16, 2020

(30) Foreign Application Priority Data
Dec. 21, 2017 (DE) 10 2017 223 578.0

(51) Int. Cl. F16K 27/02; F16K 31/06

(52) U.S. Cl. CPC F16K 27/029; F16K 31/0675; F16K 31/0655

(57) ABSTRACT

A valve has a housing and a solenoid arranged in the housing. The solenoid includes a coil, an armature, an upper stator, and a lower stator, and the stators are designed such that, when a magnetic force acts between the stators, the armature moves axially, further comprising a pin firmly connected to the armature, a cup-shaped piston connected to the pin, a spring, which moves the piston away from the solenoid in the event of a loss of the magnetic force, and a socket arranged on the housing to supply the solenoid with electric energy. A protective sleeve separates the region of the piston from the region of the socket in such a way that no medium from the region of the piston can reach the region of the socket, is arranged in the solenoid.

### CROSS REFERENCE TO RELATED APPLICATIONS

This is a U.S. national stage of Application No. PCT/EP2018/085247 filed Dec. 17, 2018. Priority is claimed on German Application No. DE 10 2017 223 578.0 filed Dec. 21, 2017 the content of which is incorporated herein by reference.

### BACKGROUND OF THE INVENTION

### 1. Field of the Invention

The invention relates to a valve comprising a housing and a solenoid arranged in the housing. The solenoid comprises a coil, an armature, an upper stator, and a lower stator. The stators are designed such that, when a magnetic force acts between the stators, the armature moves axially, further comprising a pin, which is firmly connected to the armature, a cup-shaped piston, which is connected to the pin, a spring, which moves the piston away from the solenoid in the event of a loss of the magnetic force, and a socket arranged on the housing to supply the solenoid with electric energy.

### 2. Description of Related Art

Such valves are used, inter alia, as a diverter valve on the turbocharger in motor vehicles in order to open up a bypass to the suction side in overrun operation. To prevent excessive deceleration of the turbocharger, but also to ensure a fast start-up, rapid opening and closing of the valve are essential prerequisites. In particular during the closing process, immediate closure as a result of the abutment of the piston against a valve seat is of importance. The valve seat is formed by the housing of the turbocharger, on which the valve is flange-mounted. Here, the axially displaceable piston is sealed off against the housing. The piston has openings, enabling a medium present in the bypass line to penetrate into the interior of the valve. This pressure equalization is used for the opening and closing of the valve. The disadvantage here is that the medium contains aggressive components that likewise penetrate into the interior of the valve. In this case, there is the possibility that these components may get into the region of the socket and be deposited on the contacts. This, in turn, could lead to fault messages in the control system which controls the solenoid.

### SUMMARY OF THE INVENTION

One aspect of the invention is a valve that operates in a stable manner over the long term and is reliable. The valve should furthermore be of simple and low-cost design.

One aspect of the invention is a protective sleeve, which separates the region of the piston from the region of the socket in such a way that no medium from the region of the piston can reach the region of the socket, is arranged in the solenoid. The arrangement of a protective sleeve of this kind is a particularly simple measure for separating the critical region of the piston from other regions. Despite the low outlay, it provides reliable protection from the aggressive components in the medium flowing in the bypass line. Aggressive components are thereby prevented in an effective manner from being able to penetrate as far as the electric contacts. A protective sleeve can furthermore be produced easily, and the installation of the protective sleeve also requires only a few additional working steps.

To separate the two regions, it is advantageous to produce the protective sleeve from a resistant plastic. Owing to the forces acting in the solenoid and to movements, the plastic must have a certain wall thickness. According to another embodiment, it has proven advantageous to produce the protective sleeve from high-grade steel. In addition to the excellent protective properties, high-grade steel has sufficient stability to enable the protective sleeve to be formed with thin walls. Thus, it has proven advantageous to form the protective sleeve with a wall thickness of 0.1 mm to 0.5 mm, preferably 0.2 mm to 0.4 mm and, in particular, 0.3 mm. The advantage is that the solenoid requires only slight modification for the use of such a protective sleeve. Complex redesigns of valves are not required, and even existing valves can be adapted with little effort.

One low-cost embodiment is if the protective sleeve is composed of a chromium-nickel steel.

According to one aspect of the invention, the protective sleeve has a coating made of rubber, preferably with a thickness of 0.5 mm to 1 mm, in particular, 0.7 mm. This has the advantage that the sleeve does not come into direct contact with other metal parts, at least in the region of the coating. Moreover, sealing is further improved by the coating.

According to one aspect of the invention, reliable protection of the components to be protected is achieved by virtue of the fact that the protective sleeve is arranged between the coil and the lower stator. With this arrangement, separation takes place between the region of the piston and the region of the solenoid. The region in which aggressive components occur is thereby limited to a minimum.

Secure and reliable arrangement of the protective sleeve with secure sealing is provided if the protective sleeve is pressed onto the lower stator. Additional fastening elements are thereby eliminated. The press fitting ensures that the protective sleeve remains without any change in its installed position, even in the case of high forces acting externally on the valve.

It has proven advantageous for the leaktight separation of the region of the piston from other regions of the valve to form the protective sleeve with a flange, which rests against the side of the coil that faces the piston.

### BRIEF DESCRIPTION OF THE DRAWINGS

The invention will be described in more detail on the basis of an exemplary embodiment. In the figures:

FIG. 1 is a sectional illustration of a valve according to the prior art;

FIG. 2 is a sectional illustration of the valve according to the invention; and

FIG. 3 is an enlarged illustration of the protective sleeve.

### DETAILED DESCRIPTION OF THE PRESENTLY PREFERRED EMBODIMENTS

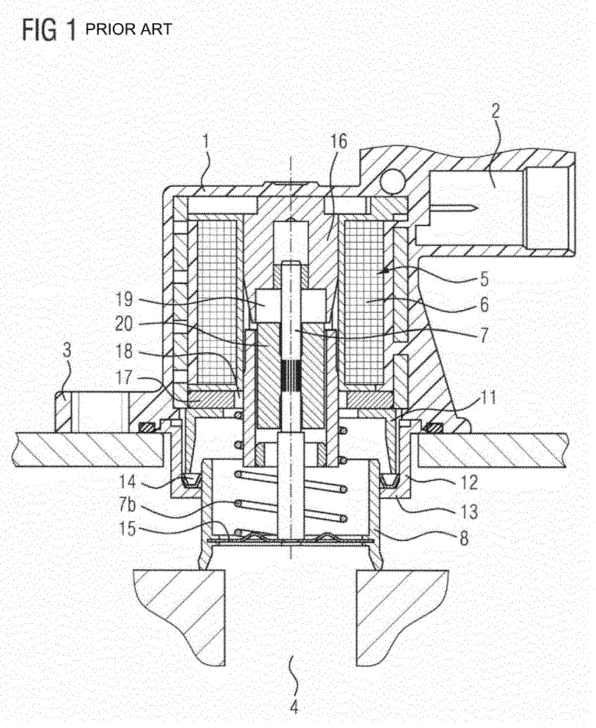

FIG. 1 shows the valve, which comprises a housing 1. The housing 1 furthermore has an integrally formed flange 3, via which the housing 1 is flanged-mounted on a turbocharger (not illustrated) in the region of a bypass line. The electrical contacting of a solenoid 5, which is arranged in the housing 1, is accomplished via a socket 2. The solenoid 5 has a coil 6, which acts on a metal pin 7. The metal pin 7 is connected to a cup-shaped piston 8, which, at the periphery of its base 9, has a sealing surface 10 that interacts with a valve seat (not illustrated). Here, a spring 7a pushes the piston 8 in the direction of the valve seat. The housing 1 furthermore has a cylindrical section 11 that extends in a direction of the piston 8. A cylinder bushing 12 connected to the housing surrounds the cylindrical section 11. The cylinder bushing 12 has a radially inwardly directed collar 13, on which a seal 14 rests. Here, the seal 14 seals off the piston 8 against the housing 1. Apertures 15 in the piston 8 allow pressure equalization in the valve. As a result, however, aggressive components in the exhaust gas also get into the interior of the valve. The solenoid 5 comprises an upper stator 16 and a lower stator 17. The two stators each have a central aperture 19, 18. In the deenergized state of the solenoid 5, an armature 20 firmly connected to the metal pin is situated in the aperture 18 in the lower stator 17. When the solenoid 5 is energized, the armature 20 and, with it, the metal pin 7 is pulled upward with the piston 8. During this process, the armature 20 enters the aperture 19 in the upper stator 16.

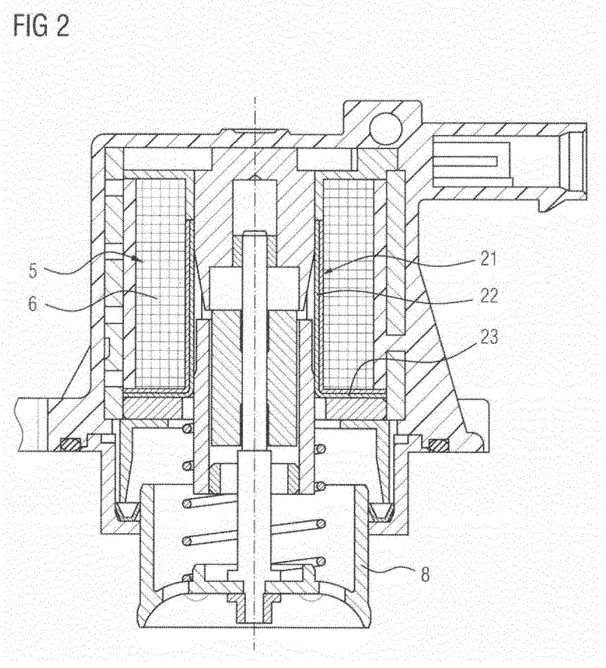

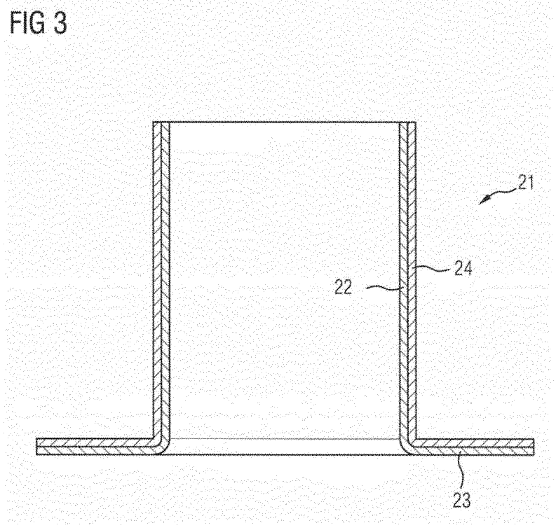

The valve according to one aspect of the invention and the protective sleeve 21 are illustrated in FIGS. 2 and 3. The valve has a protective sleeve 21 composed of chromium-nickel steel with a wall thickness of 0.3 mm. The protective sleeve has a cylindrical section 22, which merges at the lower end into a flange 23. The protective sleeve 21 rests by its cylindrical section 22 against the inside of the coil 6, and the flange 23 rests against the side of the coil 6 which faces the piston 8. Here, a rubber coating 24 on the protective sleeve 21 ensures improved sealing.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A valve comprising:
a housing;
a solenoid arranged in the housing, wherein the solenoid comprises:
a coil;
an armature;
an upper stator and a lower stator, wherein the upper stator and a lower stator are configured such that when a magnetic force acts between the upper stator and the lower stator, the armature moves axially;
a pin firmly connected to the armature;
a cup-shaped piston, which is connected to the pin;
a spring that moves the cup-shaped piston away from the solenoid in an event of a loss of the magnetic force;
a socket arranged on the housing to supply the solenoid with electric energy;
a protective sleeve is arranged in the solenoid that separates a region of the cup-shaped piston from a region of the socket such that no medium from the region of the cup-shaped piston can reach the region of the socket.

9. The valve as claimed in claim 8, wherein the protective sleeve comprises high-grade steel.

10. The valve as claimed in claim 9, wherein the protective sleeve comprises a chromium-nickel steel.

11. The valve as claimed in claim 8, wherein the protective sleeve has a wall thickness of at least one of:
0.1 mm to 0.5 mm,
0.2 mm to 0.4 mm, and
0.3 mm.

12. The valve as claimed in claim 8, wherein the protective sleeve has a coating made of rubber.

13. The valve as claimed in claim 8, wherein the protective sleeve is arranged between the coil and the lower stator.

14. The valve as claimed in claim 12, wherein the protective sleeve has a flange that rests against a side of the coil that faces the cup-shaped piston.

15. The valve as claimed in claim 12, wherein the coating made of rubber has a thickness of one of 0.5 mm to 1 mm and 0.7 mm.
